(19) United States
(12) Patent Application Publication
(10) Pub. No.: US 2008/0314685 A1
(43) Pub. Date: Dec. 25, 2008

(54) Devices and Methods For Safely Evacuating an Individual During an Emergency From a Tall Structure

(76) Inventors: Eugene Gijsbertus Maria Verstegen, Uden (NL); Joris Veeger, Zeeland (NL)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/097,075

(22) PCT Filed: Dec. 14, 2005
(86) PCT No.: PCT/EP2005/013484

§ 371 Date: Aug. 19, 2008

(51) Int. Cl. A62B 1/10

(52) U.S. Cl. 182/231

(57) ABSTRACT

The present invention relates to devices for safely lowering an individual, independent of the weight of the individual, during a fire from the higher floor levels of a tall structure to the ground level at a predetermined speed For this, the present invention provides a device (1) for safely evacuating a: individual (41) during an emergency from a tall structure comprising a rotatable drum (2), a cable (3) of suitable length wound about said drum and rotation regulating means (7) for controlling the rotation speed of said drum comprising a first member encasing an expandible second member rotatable in said first member (8), wherein the expansion of said second member (9) is controlled by the rotation speed of said drum.

The present invention relates to devices for safely evacuating an individual during an emergency from a tall structure. Specifically, the present invention relates to devices for safely lowering an individual, independent of the weight of the individual, during a fire from the higher floor levels of a tall structure to the ground level at a predetermined speed.

During emergencies such as fires, it becomes often necessary to rapidly evacuate persons from the affected structure such as a high-rise building. This can become difficult, dangerous and even impossible if access to the internal fire escapes is blocked; for example, by flames and/or smoke.

In such cases, the only available escape route may be along the exterior of the building, but ordinarily that route is, under the best of circumstances, available to only the occupants of the lowest floors of the structure.

While floors at intermediate heights of the structure could be evacuated via ladders, provided they are available, occupants of the higher floors are in great danger unless the fire can be controlled in time before it reaches and/or spreads throughout such floors.

The above, became particularly apparent when a tall structure as the World Trade Centre in New York was struck by a terrorist attack on Sep. 11, 2001. A large number of lives was lost because it became impossible to evacuate the people from the higher floors soon after the fire had started.

Attempts have been made to provide occupants of high-rise structures with a way to escape along the exterior of the building during emergencies.

Typically, this involved providing a rope or cable that is suitably anchored to the building, a mechanism frictionally engaging the rope and adapted to suspend the escaping person therefrom, and means operable by the escaping person for controlling friction to thereby lower himself at a controlled, sufficiently low speed to prevent injury upon the person's arrival on the ground.

However, these devices have a number of drawbacks, including their reliance on power from the person descending to slow the rate of descent and their need for some skill on the part of the descending person to properly operate it.

Even in case the individual to be evacuated is physically strong enough to slow rate of decent and has sufficient skill to operate the device, the mere circumstances during an emergency, like for example panic and confusion, will make it difficult for such individual to safely reach ground level.

From operational and safety points of view, it would therefore be preferred if tall structures could be fitted with escape devices which, on demand, automatically lower a person at a safe, controlled speed, independent on the weight of the individual, along the exterior of buildings without relying on the strength, dexterity, skill or consciousness of the person being lowered.

Further, such device should be able to resist high temperatures, should be reliable and hence have a relatively simple in construction, and easy to use even under difficult circumstances.

It is a goal, amongst others, of the present invention to address the above needs.

According to the present invention, this goal is achieved by providing a device for safely evacuating an individual during an emergency from a tall structure comprising a rotatable drum, a cable of suitable length wound about said drum and rotation regulating means for controlling the rotation speed of said drum comprising a first member encasing an expandible second member rotatable in said first member, wherein the expansion of said second member is controlled by the rotation speed of said drum.

According to the present invention, a tall structure can be any structure such as a multi-story office building, a skyscraper, an oil platform or a chemical plant, comprising higher floor levels which are difficult or impossible to reach from the exterior using for example ladders during an emergency such as a fire.

According to the present invention, the size of the drum is determined by the length of the cable to be wound about the drum.

If, for example, the device according to the present invention is used in a multi-story office building comprising 10 floors with a total height of approximately 40 meters and the device is fixed to the building on the 10th floor, then a cable of approximately 40 meters is necessary to safely lowering the occupants of the 10th floor to the ground level of the building.

Hence the size of the drum should be sufficient to accommodate at least approximately 40 meters of cable wound about it in order to reach ground level.

In the above situation, if the device is fixed to the 8th floor, then the drum should be capable of at least accommodating a cable of approximately 32 meters to reach ground level.

Thus, the minimal requirement for the size of the drum is, amongst others, determined by the length of the cable wound about it, which cable length in turn is at least determined by the height of the floor to be evacuated above a safe level, such as a ground level.

Such safe level is not necessary ground level since it can be envisaged that individuals to be saved can be lowered to a level above ground level and from this level use other emergency escape means such as emergency stairs or an elevator to evacuate the building.

Because of this, the phrase “a cable of sufficient length” refers to a minimal cable length necessary to reach a safe floor level allowing the individual to evacuate the tall structure.

According to the present invention, the rotation regulating means for controlling the rotation speed allow for regulating the maximal rotation speed of the drum and hence the descending speed of the individual to be saved.

Since, the rotation speed of the drum is restricted by the regulating means to a maximal rotation speed, the rate of descend of the individual to be saved is not determined by his weight, which determines only the gravitational acceleration of the descend. This means that compared to a person having less weight, the maximal rotation speed is only earlier achieved because of the higher acceleration, but his descending speed, determined by the prefixed maximal rotation speed of the drum, will not be higher.

To achieve such prefixed maximal rotation speed of the drum, the rotation regulation means comprise a first member encasing an expandible second member rotatable in said first member, wherein the expansion of said second member is controlled by the rotation speed of said drum.

According to the present invention, the rotation of the drum initiated by an individual engaging the device according to the present invention during an emergency is translated on the second member causing it to start rotating within the first member. Said rotation of the second member will cause a centrifugal force on the second member causing it to expand in the direction of the inner surface of the first member.

Because the centrifugal force is directly related to the rotation speed of the drum, the higher the rotation speed of the drum, the larger the centrifugal force on the second member will be. Because there is also a positive correlation between the centrifugal force on the second member and the expansion of the second member, at a predetermined rotation speed of the drum, the expansion of the second member will become large enough to frictionally engage the inner surface of the first member.

This frictional engagement of the second member with the first member will prevent a further increase in rotation speed of the second member and thereby the rotation speed of the drum, limiting the descending speed of the individual engaging the device according to the present invention.

According to an preferred embodiment of the present invention, the first member has a cylindrical form, thereby providing a maximal inner surface area of the first member capable of frictionally engaging the expandable second member. This allows for an optimal counter force for the centrifugal force of the second member, thereby, amongst others, minimalizing the size and weight of the rotation regulating means.

According to a more preferred embodiment of the present invention, also the second member has a cylindrical form to further maximalize the frictional engagement with the first member.

According to one preferred aspect of the present invention, the second member of the means for controlling the rotation speed of the drum comprises two or more break shoes connected by a spring mechanism.

Upon sufficient expansion of the second member, the two or more brake shoes engage the inner surface of the first member thereby providing the counter force necessary to prevent further expansion of the second member due to the centrifugal force.

On the other hand, the spring mechanism connecting the two or more brake shoes, determines the rate of expansion of the second member in response to the centrifugal force created by the rotation speed of the drum.

Specifically, the stronger the spring force of the spring mechanism connecting the two or more break shoes, the higher centrifugal force, and hence rotation speed of the drum, is necessary before the second member frictionally engages the inner surface of the first member.

In other words, the spring force counteracts the centrifugal force thereby allowing to easily predetermine the maximal rotation speed of the drum by adjusting the strength of the springs employed.

Usually, a rotation speed of the drum is predetermined to allow a descending speed of the individual to be saved of 2 to 20 km/h, preferably, 5 to 15 km/h, more preferably 5 to 10 km/h by adjusting the counter force provided by the spring mechanism.

In a particularly preferred embodiment, the drum and cable are embodied in metal. Embodying these components of the device according to the present invention in metal provide maximal resistance to, for example, high temperatures caused by a fire.

In addition, embodying the cable in metal allows for a reduction of the weight of the cable which is determined by both the necessary length of the cable for reaching a safe floor level and the weight of the individual it should be able carry without breaking. Metal provides, using relatively thin cables, a considerable weight reduction and loading capacity.

Because of the resistance of metal to fire, also the regulating means for controlling the rotation speed are preferably embodied in metal. However, it can be envisaged that certain specific parts of the rotation speed regulation means are not embodied in metal such as for example the breaking shoes of the second member.

To facilitate attachment of the device according to the present invention to a tall structure, the device preferably comprises means for attachment of the device to the tall structure such as a framework encasing the device according to the present invention.

Preferably, the device according to the present invention further comprises means for attachment of the individual to the end of the cable. Such means can for example be a hook, a harness, a seat, a cage, a loop, and a handle.

In one other preferred embodiment, the device according to the present invention comprises means, such as a handle or a motor, for rewinding the cable about the drum after the device has been used to evacuate one individual. This embodiment allows for the evacuation of multiple individuals using a single device.

The device according to the present invention provides on demand, automatically lowering of a person at a safe, controlled speed, independent of the weight of the individual, along the exterior of buildings without relying on the strength, dexterity, skill or consciousness of the person being lowered.

Further, the device according to the present invention is resistant to high temperatures, is reliable resistant easy to use even under difficult circumstances.

Therefore, the present invention also relates to a method for safely evacuating an individual during an emergency from a tall structure comprising attachment of the individual to the device according to the present invention and lowering the individual to the ground level using the device.

Preferably, the above method for safely evacuating individuals during an emergency from a tall structure comprises:
(a) attachment of a first individual to a device according to the present invention;
(b) lowering the first individual to a safe level using the device;
(c) rewinding the cable about the drum;
(d) attachment of a second individual to a device according to the present invention;
(e) lowering the second individual to the ground level using the device; and
(f) optionally, repeating steps (c) to (e).

Certain preferred embodiments of the present invention will be further illustrated by the accompanying drawings wherein:

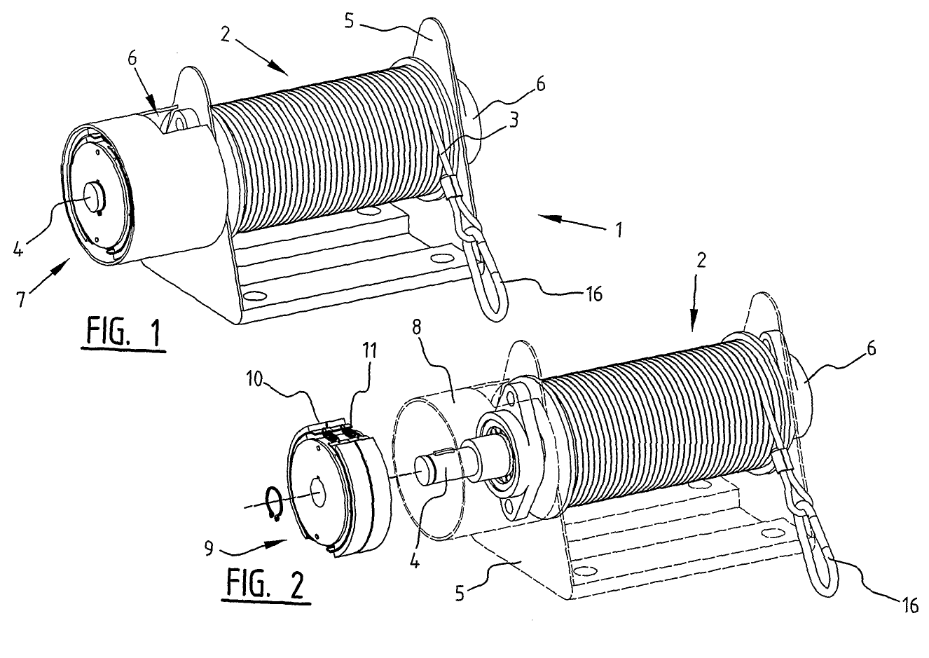

FIG. 1: represents a view in perspective of a device according to the present invention;

FIG. 2: represents an exploded view of the device shown in FIG. 1;

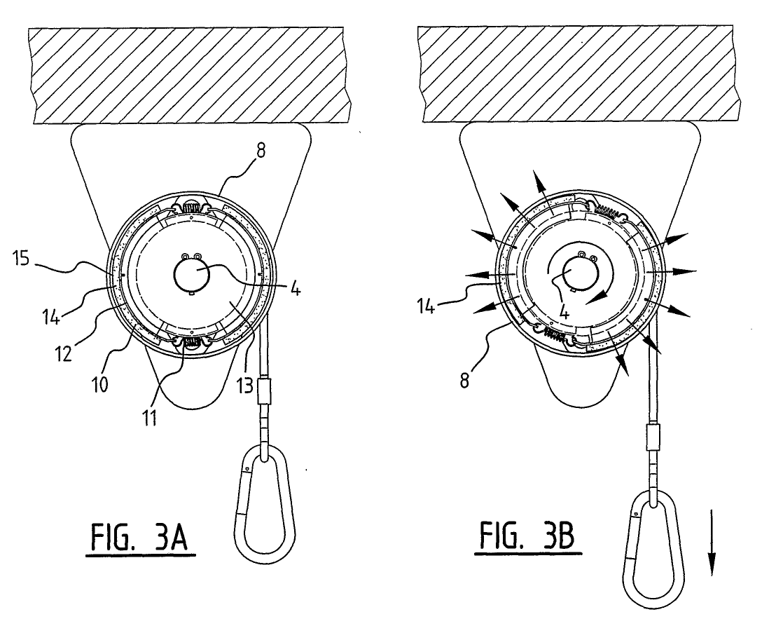

FIG. 3: represents a detailed view of the device shown in FIG. 1 in the free rotation mode (A) and in the inhibited rotation mode (B);

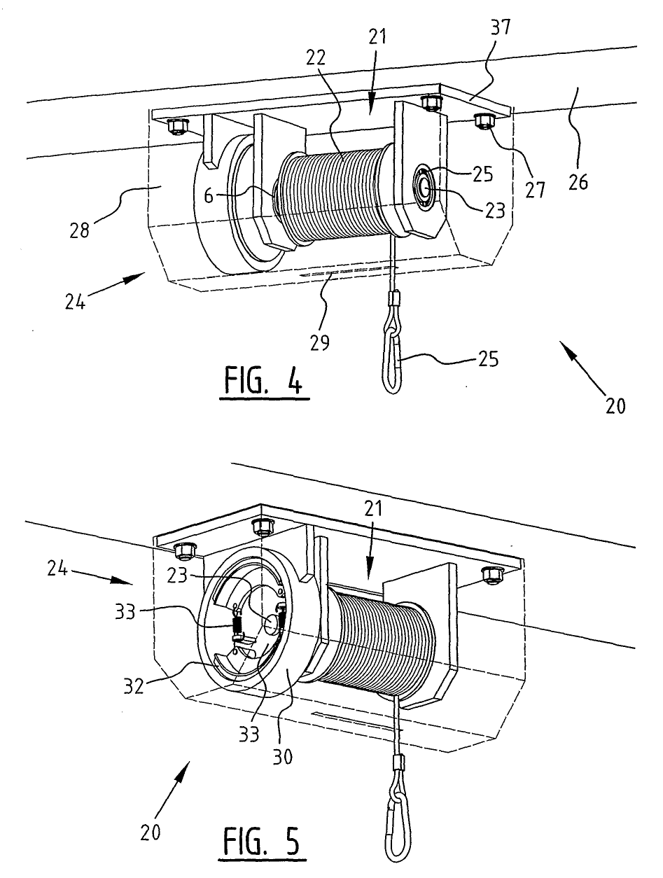

FIG. 4: represents a view in perspective of an other preferred embodiment of a device according to the present invention;

FIG. 5: represents an exploded view of the device shown in FIG. 4;

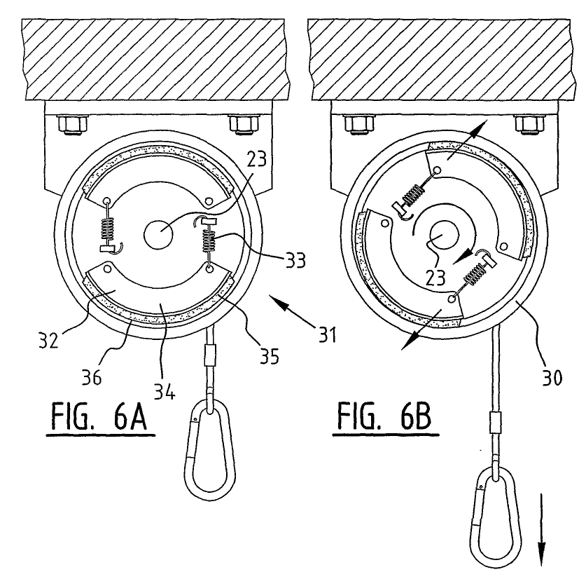

FIG. 6: represents a detailed view of the device shown in FIG. 4 in the free rotation mode (A) and in the inhibited rotation mode (B);

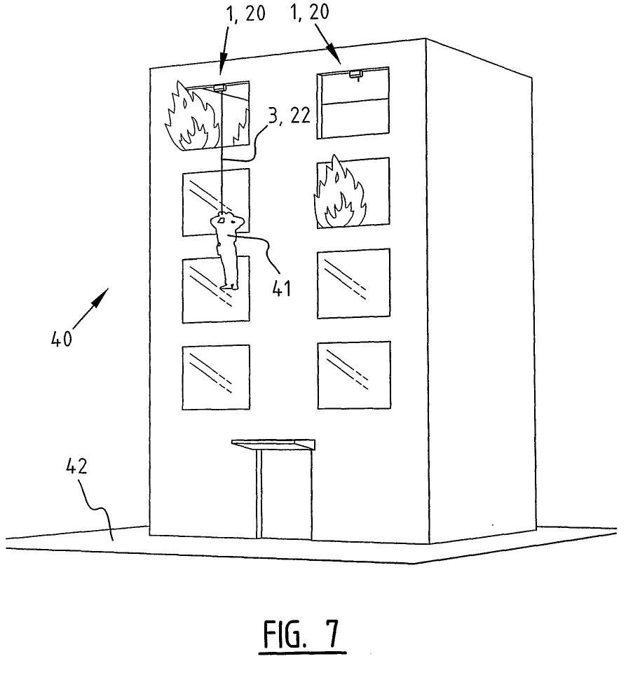

FIG. 7: represents a schematic drawing of an individual which is lowered from a tall structure using a device according to the present invention attached to the tall structure during a fire.

Specifically, FIG. 1 shows a safety device (1) according to the present invention comprising a drum (2) and a cable (3) of suitable length wound about said drum (2). The drum (2) is mounted on an axle (4) rotatable in a frame (5) using ball-bearings (6). The axle (4) translates the rotation of the drum to rotation regulating means (7) also conveniently mounted on frame (5).

In the preferred embodiment shown in FIG. 1, a hook fastener (16) connected to cable (3) allows coupling of an individual to be saved to the safety device (1) according to the present invention.

FIG. 2 shows the above described safety device in an exploded view specifically detailing the rotation regulating means (7). The rotation regulating means shown comprise a first substantially cylindrical member (8) encasing a second substantially cylindrical member (9). In the preferred embodiment shown, the second substantially cylindrical member (9) comprises two elements (10) connected to each other by a spring mechanism (11).

Upon rotation of axle (4), the second substantially cylindrical member (9) starts to rotate in the substantially cylindrical first member (8). This rotation will create a centrifugal force causing the second substantially cylindrical member (9) to expand. This expansion drives the two elements (10) in the direction of the inner surface of the substantially cylindrical first member (8).

However, the expansion of the second substantially cylindrical member (9) is counteracted by the spring mechanism (11) providing control the rate of expansion of the second substantially cylindrical member (9).

This control allows to predetermine at which rotation speed of the axle (4) and thereby the drum (2), the two expandable members (10) will frictionally engage, and hence limit the rotation speed of the drum (2), the inner surface of the first substantially cylindrical member (8).

A detailed view of the two expandable elements (10) and the spring mechanism (11) shown in FIG. 2, is provided in the FIGS. 3A and 3B.

FIG. 3A shows the expandable elements (10) comprising a portion (12) providing the attachment of the spring mechanism (11) and the translation of the rotation of the axle (4) on portion (12) through element (13).

The outer surface of portion (12) is at least partially covered by a layer (14) for frictionally engaging the inner surface of the first substantially cylindrical member (8). When the axle (4), and hence the drum (2), is not rotating, meaning that the device (1) according to the present invention is not in use, or the axle (4) is rotating at a speed lower than a predetermined speed controlled by the spring mechanism (11), than the gap (15) between the first substantially cylindrical member (8) and the layer (14) provides free rotation of the second substantially cylindrical member (9).

However, at a predetermined rotation speed of the axle (4), as shown in FIG. 3B, the layer (14) will frictionally engage the inner surface of the substantially cylindrical first member (8), thereby inhibiting a further increase of the rotation of the axle (4) and, as consequence, the rotation of the drum (2) thereby allowing a control descend of an individual to be rescued.

FIG. 4 shows another preferred embodiment of the safety device (20) according to the present invention comprising a drum (21) and a cable (22) of suitable length wound about said drum (21). The drum (21) is mounted on an axle (23) rotatable in a frame (37) using ball-bearings (25). The axle (23) translates the rotation of the drum to rotation regulating means (24) also conveniently mounted on frame (37).

In the preferred embodiment shown in FIG. 4, a hook fastener (25) connected to cable (22) allows coupling of an individual to be saved to the safety device (20) according to the present invention.

Frame (37) is attached to the tall structure (26) using bolt/nut (27) connections. The entire safety device (20) is surrounded by an enclosure (28) comprising an opening (29) to allow the cable (22) to pass through.

FIG. 5 shows the above described safety device in an exploded view specifically detailing the speed regulating means (24). The rotation regulating means shown comprise a first substantially cylindrical member (30) encasing a second substantially cylindrical member (31). In the preferred embodiment shown, the second substantially cylindrical member (31) comprises two elements (32) connected to each other by a spring mechanism (33).

Upon rotation of axle (23), the second substantially cylindrical member (31) starts to rotate in the first substantially cylindrical first member (30). This rotation will create a centrifugal force causing the second substantially cylindrical member (31) to expand. This expansion drives the two elements (32) in the direction of the inner surface of the substantially cylindrical first member (30).

However, the expansion of the second substantially cylindrical member (31) is counteracted by the spring mechanism (33) providing control the rate of expansion of the second substantially cylindrical member (31).

This control allows to predetermine at which rotation speed of the axle (23) and thereby the drum (21), the two expandable members (32) will frictionally engage, and hence limit the rotation speed of the drum (21), the inner surface of the first substantially cylindrical member (30).

A detailed view of the two expandable elements (32) and the spring mechanism (33) shown in FIG. 5, is provided in the FIGS. 6A and 6B.

FIG. 6A shows the expandable elements (32) comprising a portion (34) providing the attachment of the spring mechanism (33) and the translation of the rotation of the axle (23) on the second substantially cylindrical member (31).

The outer surface of the portion (34) is at least partially covered by a layer (35) for frictionally engaging the inner surface of the first substantially cylindrical member (30). When the axle (23), and hence the drum (21), is not rotating, meaning that the device (20) according to the present invention is not in use, or the axle (23) is rotating at a speed lower than a predetermined speed controlled by the spring mechanism (33), than a gap (36) between the first substantially cylindrical member (30) and the layer (35) provides free rotation of the second substantially cylindrical member (31).

However, at a predetermined rotation speed of the axle (23), as shown in FIG. 6B, the layer (35) will frictionally engage the inner surface of the substantially cylindrical first member (30), thereby inhibiting a further increase of the rotation of the axle (23) and, as consequence, the rotation of the drum (21), thereby allowing a control descend of an individual to be rescued.

FIG. 7 shows the use of a safety device (1, 20) according to the present invention during an emergency. The safety device (1, 20) is firmly attached to a tall structure (40). The individual (41) to be rescued attaches himself to the cable (3, 22) and is lowered, at a predetermined speed independent of the weight of the individual (41), by the safety device (1, 20) along the exterior of the tall structure (40) to a safe level (42), in the embodiment shown the ground level.

1. Device for safely evacuating an individual during an individual during an emergency from a tall structure comprising a rotatable drum, a cable of suitable length wound about said drum and rotation regulating means for controlling the rotation speed of said drum comprising a first member encasing an expandable second member rotatable in said first member, wherein the expansion of said second member is controlled by the rotation speed of said drum.

2. Device according to claim 1, wherein the first member has a cylindrical form.

3. Device according to claim 2, wherein the second member has a cylindrical form.

4. Device according to claim 1, wherein the expandible second member comprises two or more break shoes connected by a spring mechanism.

5. Device according to claim 1, wherein the drum and cable are embodied in metal.

6. Device according to claim 1, wherein the regulating means for controlling the rotation speed are embodied in metal.

7. Device according to claim 1, wherein the device comprises means for attachment of the device to the tall structure.

8. Device according to claim 1, wherein the device comprises means for attachment of the individual to the cable.

9. Device according to claim 8, wherein the means for attachment of the individual to the cable are selected from the group consisting of a hook, a harness, a seat, a cage, a loop, and a handle.

10. Device according to claim 1, comprising means for winding the cable about the drum.

11. Method for safely evacuating an individual during an emergency from a tall structure comprising attachment of the individual to a device according to claim 1 and lowering the individual to a safe level using the device.

12. Method for safely evacuating individuals during an emergency from a tall structure comprising:
(a) attachment of a first individual to a device according to claim 1;
(b) lowering the first individual to a safe level using the device;
(c) rewinding the cable about the drum;
(d) attachment of a second individual to the device according to claim 1;
(e) lowering the second individual to the ground level using the device; and
(f) optionally, repeating steps (c) to (e).
